(19) United States
(12) Patent Application Publication
(10) Pub. No.: US 2018/0066789 A1
(43) Pub. Date: Mar. 8, 2018

(54) High Thermal Efficiency Tube for Conveying Fluids

(71) Applicant: Mário César Batista SANTOS, Vitória, ES (BR)

(72) Inventors: Mario Cesar Batista Santos, Vitoria (BR); Douglas Koech Branco, Vitoria (BR)

(21) Appl. No.: 15/545,528

(22) PCT Filed: Jan. 20, 2016
(86) PCT No.: PCT/BR2016/000010

§ 371 Date: Nov. 28, 2017

(30) Foreign Application Priority Data
Jan. 21, 2015 (BR) BR1020150013361

(51) Int. Cl. F16L 59/147; F16L 9/18; F16L 15/00

(52) U.S. Cl. CPC F16L 59/147; F16L 15/006; F16L 9/18

(57) ABSTRACT

This invention refers to a heat-insulated fluid injector tube through the development of a technology capable of increasing thermal efficiency by the use of high-efficiency conformed thermal insulation, which promotes uniform density and thickness of the Insulating layer in the annular space between concentric tubes, as well as by reducing the risk of welding failure in the union of concentric tubes by using a specific geometry in welds, which promotes adequate distribution of mechanical efforts arising from the Difference of dilation between the inner tube and the outer tube.

### FIELD OF INVENTION

This invention refers to a rigid tube of double walls, with weld of union in the extremities and with the annular space filled with high efficiency thermal insulation.

It is also referenced the use of the aforementioned invention for the injection of steam in the recovery of high viscosity oils, such as in the exploration of oil wells, hereinafter referred to as a HIGH-EFFICIENCY THERMAL PIPE FOR THE CONDUCT OF FLUIDS.

### FOUNDATIONS OF INVENTION

The proposed invention refers to a HIGH-EFFICIENCY THERMAL PIPE FOR THE CONDUCT OF FLUIDS to be used for conducting of various fluids with minimal thermal power loss.

In the case of the use of the aforementioned invention, it is very useful in the recovery of oil wells, because it is only possible to recover, in practice, a fraction of the oil in the reservoirs while most of the oil remains within the tank, due to the complexity of the reservoirs and to the mechanisms which are still inefficient for oil recovery. Therefore, it becomes necessary the continuous study and development of methodologies for the recovery process that allow to extract more residual oil thereby increasing the profitability of the oilfields, extending its lifetime.

The increase in the importance of heavy oils within the energy scenario enables the exploitation of reservoirs initially were regarded as unprofitable.

Oil companies in general are looking for new technologies that can elevate the oil recovery factor contained in their reservoirs. These investments have as main objective the increase of the economy of oil production processes, which are high.

The injection of steam is one of the most commonly used special methods in oil recovery. In this method, the steam is injected into the reservoir aiming to reduce the viscosity, improving mobility and thereby facilitating its extraction. The saturated steam, from the steam generators on the surface, is injected into the oil reservoir through the steam injection pipe installed in the injector pit. In the well producer, the oil-water-gas mixture is extracted from the reservoir and directed to the collector station.

In the current methods of steam injection, the steam generated on the surface is driven up to large depths through special ducts called steam injectors, connected to each other by threaded gloves, forming large columns of steam injection. Each tube for steam injection consists of two steel tubes with different jacketed diameters, i.e. a tube inserted inside a tube-shirt. The annular space, formed between the tubes, is filled with high-efficiency thermal insulators, which must ensure that the steam thermal energy, promoted by the pressure and temperature, is maintained throughout the entire length of the tubing until the reservoir reaches the oil, thus ensuring the thermal energy is used in reducing the viscosity of heavy oils.

### RELATED TECHNIQUE

In relation to the methods of recovery of high viscosity oils, the most commonly used method is the injection of heated fluids (PETROBRAS). Fundamentos de engenharia de petróleo [Fundamentals of Petroleum Engineering]/José Eduardo Thomas, organizer. 2. Ed.—Rio de Janeiro: Interscience: PETROBRAS, 2004), specifically steam-shaped heat to improve the flow. In the state of the technique of the current methods of steam injection, the steam generated on the surface is driven up to large depths through special ducts called steam injectors, connected to each other by threaded gloves, forming a large column of steam injection. Each steam injection tube consists of two steel tubes with different jacketed diameters, that is, a tube inserted inside a tube-shirt. In the annular space, formed between the inner and outer tube is applied a high-efficiency thermal insulation, which has the function of ensuring that the thermal energy of the fluid remains with little heat dissipation along the entire duct line to the pit so that the decrease of the viscosity of heavy oils have the efficiency expected. The steam injector tube is a high-cost item, which involves noble materials and a set of delicate processes during its manufacture. The efficiency of the steam injector tube is directly connected to the thermal insulation used and the mechanical resistance of the assembly. The more severe the operational conditions, the faster the wear of the tubes and/or cracks walls in the welds of the jacket, thus compromising the thermal insulation of the tubing and the efficiency of the steam injection system. The connections are also critical points, because with the wear of the threads, one loses the column's water tightness, resulting in steam leakages and a low process efficiency.

In this sense, several attempts to improve the performance of steam injectors in oil recovery in underground wells have been developed, such as the patent BRPI8601182, “INSULATED TUBULAR DUCT, CONCENTRIC WALLS FOR FORMING A TUBULAR SPINE IN UNDERGROUND WELL”, with a deposit date on Mar. 17, 1986, where it describes an isolated duct with concentric walls, having an annular space between the walls within which insulating materials are deposited and sealed in the same. A disadvantage of this patent is the need to include the process of forging the inner tube, aiming to increase its diameter at the extremities, for only afterwards, to weld the union between the tubes. This is a process that requires extreme caution, because there is the risk of not maintaining the repeatability of the internal tube conformation after the forging process and with that, the welding parameters must be constantly altered, being difficult to maintain the same quality in these processes. This invention surpasses this difficulty, as a new technology has been developed, described in this invention of the HIGH-EFFICIENCY THERMAL TUBE FOR THE CONDUCT OF FLUIDS, which refers to an innovative welding technology in concentric pipes conducted in automated form and requiring fewer welding seams, both in the filling phase of the inner tube and in the union phase of the internal and external tubes. Another drawback is the use of two types of insulators, and the model used in the extremities utilizes partial vacuum. This invention uses only one type of thermal insulation without the need for vacuum use, as there is a fracture in the tube, one loses the vacuum and consequently the efficiency of the insulation.

The technology described in the WO9532355 patent, “DOUBLE WALLET insulate TUBING AND METHOD OF INSTALLING SAME”, deposited on Nov. 30, 1995, deals with surpassing the state of the technique using vacuum as a main characteristic for the increased efficiency of thermal insulation. However, this technology, as already described above, has the great drawback to maintaining the vacuum, as any tube wear or even broken in the welding, one loses its efficiency. This invention surpasses this difficulty using a high-performance and easy-to-handle thermal insulation, ensuring the efficiency of the steam injector tube. Another differential is that the present invention has only one outer sleeve of the union, which improves the mounting process of the injection column.

Another dual-wall tube, thermally insulated and utilizing the pre-vacuum for the application of thermal insulation, designed for steam injection purposes, is revealed in the BRPI0702437 patent application, “THERMALLY INSULATED TUBE (MAGL) FOR STEAM INJECTION INTO OIL WELLS”, deposited on Jul. 20, 2007. This technology has the disadvantage in the application of the thermal insulator and the mechanism to maintain the inner and outer concentric tube, as it is necessary to install up to six centralized rings in the inner tube before insertion of the same in the outer tube to then perform an orifice on each end of the outer tube so that vacuum pumps are installed with the purpose of sucking, thus filling the annular space with the thermal insulation. The need to acquire vacuum pumps and the inclusion of one more element, the centralized rings, causes the productive process to be longer, requiring a greater number of man-hour during the process, reflecting on the increase of the manufacturing cost and consequently in the end product. In this sense, THE HIGH-EFFICIENCY THERMAL TUBE FOR THE CONDUCT OF FLUIDS has great economic advantage and thermal efficiency through its innovative manufacturing process, with the application of thermal insulation and in the welding process developed to attach concentric tubes.

Another problem commonly reported in the state of the technique and the market is the frequent exchange of pipes due to the reduction of efficiency of the steam injection process in oil wells according to failures in the welds of the concentric pipes and thermal insulation failures. The invention of the HIGH-EFFICIENCY THERMAL TUBING FOR THE CONDUCT OF FLUIDS described herein aims to overcome the problems encountered in the thermal efficiency of the steam injectors described in the state of the technique and the intent to overcome the difficulties encountered in the market, such as: low insulation efficiency; shelf life of tubes lower than desired; and high cost of the final product.

### INVENTION SUMMARY

The present invention refers to a thermally insulated conduit tube through the development of a technology capable of enhancing thermal efficiency by the use of high-efficiency conformed thermal insulation, which has uniform density and thickness for application in annular spaces between concentric tubes, as well as by reducing the risk of failure in the welding of the concentric tubes by using a material with high strength and high ductility and still due to the use of an angular geometry of weld, which promotes adequate distribution of mechanical efforts arising from the difference of dilation between the inner tube and the external.

### BRIEF DESCRIPTION OF THE FIGURES

FIG. 1 shows the parts that comprise the HIGH THERMAL EFFICIENCY TUBE FOR THE CONDUCT OF FLUIDS.

FIG. 2 shows the detailing of the welding geometry of the union between the pipes that comprise the HIGH THERMAL EFFICIENCY TUBE FOR THE CONDUCT OF FLUIDS.

FIG. 3 introduces the manufacturing process of the higher-efficiency thermal tubing for fluid conducting.

### DETAILED DESCRIPTION OF THE INVENTION

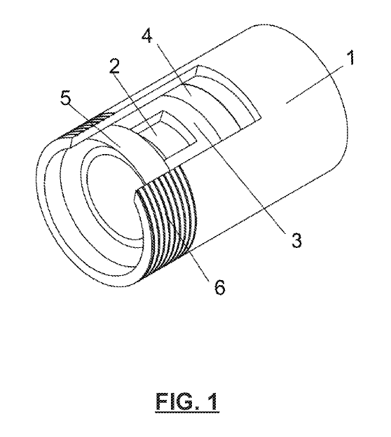

The invention described as a HIGH THERMAL EFFICIENCY TUBE FOR THE CONDUCT OF FLUIDS is presented in a non-limited way to this model, as shown in FIG. 1, consisting of: an outer tube (1) and an inner tube (2), thermal insulator (3) composed of a high-efficiency insulating quilt, including at elevated temperatures, which fills the annular space between the inner and outer tubes, avoiding the transfer of heat between the tubes and ensuring the concentric centralization of them; Aluminized Tape (4) reinforced and able to maintain its efficiency even at high temperatures, it allows fixing the compressor insulating over the inner tube avoiding superficial irregularities, thus facilitating insertion and concentricity with the outer tube; Welding Union (5) which allows the union between the inner tube and the outer tube, sealing the thermal insulation inside the annular space; Connection/thread (6) external used to connect a tube in the other by threaded sleeves resulting in a pipe column.

Depending on the metallurgical characteristic of most tubes used for the injection of fluids, its welding promotes the formation of a thermally affected zone (ZTA) susceptible to formation of fragile phases, which, due to the characteristic of the process of manufacturing of the concentric tubes for the use of steam injection, they are basically at the extremities. In this context, the use of welding to enable the concentricity of a tube in relation to the other will entail in a more problematic exact metallurgical match region, which may be the object of failures, both during assembly and during the steam injection process. To overcome such problems has been developed a new technology in the welding procedure, through automation of the same, with more stable welds, as well as greater control of the warehouse, increasing productivity and ensuring better metallurgical characteristics in the welded joints, thereby minimizing the problems generated by fragility in ZTA.

In the design of the innovative process of welding for the production of concentric tubes were taken into consideration the tensions generated during the welding process and also during the process of conducting the fluid heated by the tube, where the primary dilation of one of the tubes before the welding promotes the equalization of tension levels when in service.

Through numerical, structural and also the development of a simulation with components of tubes already welded, where the application of simultaneous uniaxial compressive loads, on the walls of the two concentric tubes, higher than those experienced by the pipes in service have shown that the tensions in service, for tubes manufactured with the innovative welding technology, will be within the elastic regime, allowing the minimization and even elimination of the failures arising from the process of connecting tubes.

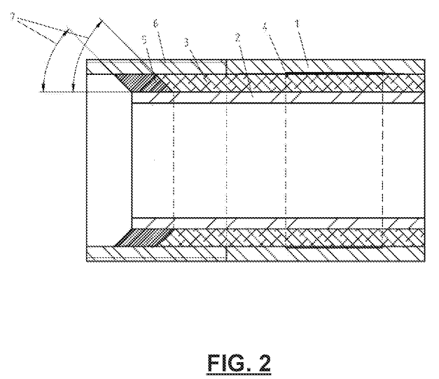

As failures basically happen by combining the metallurgical changes in the ZTA and the field of tensions generated by the welding process, the injection process and the assembly process, the welding comes to be a component of paramount importance in the manufacture of these components. Thus, the new welding technology involves controlling tensions through the uniform distribution of these tensions at the edges of the tubes. So, this new technology operates in two ways. One is directly in the metallurgical characteristics of the union, in order to minimize the incidence of fragile phases, in addition to equalizing the tensions arising from the welding, and the other, is through a geometrical optimization of the weld between 30 and 60° (7) described in FIG. 2, which allows the tension levels during the driving of heated fluids are minimized, and may even reach the elimination of the most complex tensions.

Therefore, the object of the welding process is the production of a piped tube composed of one tube inside the other, filled with thermal insulation, with welds at the extremities, joining the outer surface of the inner tube to the inner surface of the outer tube. The tubes should maintain concentricity and mechanical characteristics suitable for field requests.

For the execution of the welds, a consumable of metallurgical characteristic related to the material of the tube is applied, in order to ensure, in the weld, a greater mechanical resistance, for the fact that it is positioned at the ends of the tubes, and this region is liable for greater mechanical requests in relation to other regions of the tube. Therefore, due to the metallurgical characteristic of the warehouse, this should not be affected by failures related to mechanical resistance or fragility.

The welding process of the pipes is accomplished through an automated system ensuring the reproducibility of the welded joints, in which the control of the metallic transfer is established in such a way as to minimize the heat intake and, consequently, greater control of the affected thermally zone. (ZTA).

Another advantage of the invention is in the manufacturing process of the modified buttress type, through laboratory testing was proven that the use of a five-pointed Penta tablet with 2 edged edges and lateral fixation by bolt and fitting, generates a cost savings in manufacturing process when compared to Mono edge inserts. For this way, the Penta tablet can have its lifetime of five times more than the Mono edge model before the need for replacement. The holder of the tablet is manufactured in special steel and has specific geometry in order to ensure greater rigidity in the fixing of the tablet, greater precision and better finishing of the threaded fillets.

Some samples of high-efficiency thermal insulators have been tested in the laboratory for the purpose of ensuring the highest thermal efficiency for the fluid conductive tube of this invention. The test consisted of providing heat from the inside of the three tubes, each with different thermal insulators applied, to check the temperature of the outer face of the outer tube using for this a temperature measuring equipment known as pyrometer. The thermal efficiency of the following samples has been verified: Airgelgel quilt; Airgel quilt; 2—Microporous insulation; sample 3-ceramic fiber. Sample 1 showed a thermal efficiency 30.4% higher than sample 2 and 24.7% higher than sample 3. The thermal efficiency of sample 1 was also compared to a tube used in the national market also composed of nanotechnology for thermal insulation, the sample 1.14% more efficient. In this way, we chose to use the thermal insulation of sample 1 in this invention due to its high thermal efficiency demonstrated.

The thermal insulation (3) applied in the annular space between the inner and outer tubes consists of a high-efficiency insulation quilt, known as thermal super insulator, such as the aerogel of silica and fiberglass covered by aluminized tape, avoiding the heat transfer between tubes and ensuring concentric centralization of them.

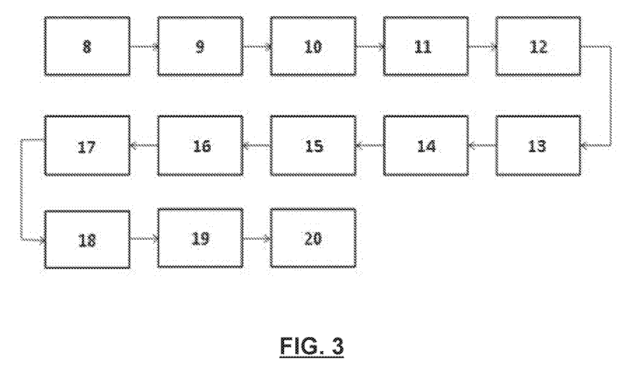

The manufacturing process of the HIGH-EFFICIENCY THERMAL TUBE TO CONDUCT FLUIDS, according to FIG. 3, consists of the following steps: Cutting the original threads of the inner tube (8); Filling welding at both ends of the inner tube (9); Bi-sealing in the filling weld of the two ends for adjusting the predetermined degree (10); Cutting of the original threads of the outer tube as parameter the final length of the inner tube (11); Defining the dimensions and cutting of the thermal insulation according to the specifications of the inner tube (12); Application of thermal insulation in the inner tube so as to make it just in the tube (13); Aluminized Tape application for thermal insulation fixation (14); Insertion of the inner tube into the outer tube (15); Welding of the pipes in one of the extremities, accompanying the predetermined angle in the bi-sealing (16); Pre-heating of the inner tube to reach the axial dilation established (17); Welding of the Union at the opposite end (18); Thermal treatment for relief of microstructure tensions and fixes in the welds (19) regions; Threading at the ends of the outer tube (20).

1. A high-efficiency thermal tube for conducting fluids characterized by an outer tube (1), an inner tube (2), at least one thermal insulator (3), at least one aluminized tape (4), soldering Union (5) and connection/thread (6).

2. The high-efficiency thermal tube for conducting fluids, according to claim 1, characterized by owning an inner tube (2) concentric to the outer tube (1) with an annular space filled by a thermal insulator (3) covered by tape aluminized (4).

3. The high-efficiency thermal tube for conducting fluids, according to claim 2, characterized by possessing a thermal insulator (3) formed by a high efficiency thermal insulation.

4. The high-efficiency thermal tube for conducting fluids, according to claim 1, characterized by an inner tube (2) concentric to the outer tube (1) with an annular space filled with alternating layers of thermal insulation (3) covered by aluminized tape (4).

5. The high-efficiency thermal tube for conducting fluids, according to claim 4, characterized by possessing a thermal insulator (3) formed of airgel of silica and fiberglass covered by aluminized ribbon (4).

6. The high-efficiency thermal tube for conducting fluids, according to claim 1, characterized by possessing a ribbon aluminized (4) in the annular space for the elimination of surface irregularities of the thermal insulation (3).

7. The high-efficiency thermal tube for conducting fluids, according to claim 1, characterized by possessing a ribbon aluminized (4) as thermal insulation coating cover (3) for reducing friction between thermal insulation and outer tube (1) in the process of Assembly.

8. The high-efficiency thermal tube for conducting fluids, according to claim 1, characterized by possessing a ribbon aluminized (4) as thermal insulation coating coverage (3) for reducing friction between thermal insulation and outer tube (1) in Thermals dilation between the inner tube (2) and outer tube (1).

9. The high-efficiency thermal tube for conducting fluids, according to claim 1, characterized by having welding union (5) for thermal insulation sealing (4) in the annular space between the outer tube (1) and the inner tube (2).

10. The high-efficiency thermal tube for conducting fluids, according to claim 9, characterized by possessing bisotagem varying between 30° and 60° (7) in the inner tube (2).

11. The high-efficiency thermal tube for conducting fluids, according to claim 9, characterized by having welding of union (5) with electrode ferritic.

12. The high-efficiency thermal tube for conducting fluids, according to claim 9, characterized by having weld of Union (5) with fill weld cords ranging from 30° to 60° (7) on the surface of the inner tube (2).

13. The high-efficiency thermal tube for conducting fluids, according to claim 1, characterized by possessing connection/thread (6) manufactured in the modified buttress model at its ends to fit in the sleeves of the tubes.

14. A process for production of a high-efficiency thermal tube for conducting fluids characterized by possessing the following critical steps:
Cutting of the original threads of the inner tube (8);
Filling welding at both ends of the inner tube (9);
Bi-sealing in the filling weld of the two extremities for adjusting the predetermined degree (10);
Cutting of the original threads of the outer tube as parameter the final length of the inner tube (11);
Definition of the dimensions and cut of the thermal insulation according to the specifications of the internal tube (12);
Application of thermal insulation in the inner tube so as to make it just in the tube (13);
Aluminized tape application for thermal insulation fixation (14);
insertion of the inner tube into the outer tube (15)
Welding of the pipes in one of the extremities, accompanying the predetermined angle in the beveling (16);
Pre-heating of the inner tube to reach the axial dilation established (17);
Welding of the union at the opposite end (18);
Thermal treatment for relief of micro structure tensions and fixes in the welds (19) regions;
Threading at the edges of the outer tube (20);

15. The process for production of the high-efficiency thermal tube for conducting fluids, according to claim 14, characterized by producing a filling welding at the ends of the inner tube with an angle between 30° and 60° (7).

16. The process for production of the high-efficiency thermal tube for conducting fluids, according to claim 14, characterized by producing a beveling to fit the weld degree of the pipes with an angle between 30° and 60° (7).

17. The process for production of the high-efficiency thermal tube for conducting fluids, according to claim 14, characterized by the welding of the inner tube (2) in the outer tube (1) with an angle between 30° and 60°.

18. The process for production of the high-efficiency thermal tube for conducting fluids, according to the claim 14, characterized by having heating with pre-dilation of the inner tube (2) at temperatures between 250° C. and 450° C.

19. The process for production of the high-efficiency thermal tube for conducting fluids, according to the claim 14, characterized by preheating in the welding region at temperatures between 250° C. and 450° C.

20. The process for production of the high-efficiency thermal tube for conducting fluids, according to the claim 14, characterized by possessing thermal treatment and relief of tensions in the welding region at temperatures between 250° C. and 450° C.

21. The process for production of the high-efficiency thermal tube for conducting fluids, according to the claim 14, characterized by possessing threads of type buttress modified at the ends of the outer tube (1) through the use of 5-pointed penta gum with 2 End edges and lateral fixation by bolt and fitting.

22. The process for production of the high-efficiency thermal tube for conducting fluids, according to the claim 21, characterized by the holder of the tablet be manufactured in special steel and with specific geometry in order to ensure greater rigidity in the fixing of the tablet, greater precision and better finishing of threaded fillets.
